(19) United States
(12) Patent Application Publication
(10) Pub. No.: US 2026/0124913 A1
(43) Pub. Date: May 7, 2026

(54) CAPACITIVE SENSING INPUT DEVICE

(71) Applicant: Panasonic Automotive Systems Co., Ltd., Kanagawa (JP)

(72) Inventors: Shinji KANDA, Osaka (JP); Sho SONODA, Osaka (JP); Kento WAKIDA, Osaka (JP)

(73) Assignee: Panasonic Automotive Systems Co., Ltd., Kanagawa (JP)

(21) Appl. No.: 19/343,749

(22) Filed: Sep. 29, 2025

(30) Foreign Application Priority Data
Nov. 7, 2024 (JP) 2024-195131

(51) Int. Cl. B60K 35/10

(52) U.S. Cl. CPC B60K 35/10; B60K 2360/1434; B60K 2360/27; B60K 2360/332

(57) ABSTRACT

A capacitive sensing input device includes: a resin layer that is light transmissive and includes a front surface that is a design surface; a capacitive sensor sheet that overlaps a back surface of the resin layer; and a light source (light-emitting element) that emits light to the resin layer and the capacitive sensor sheet. The resin layer includes non-uniform light transmittance, and the capacitive sensor sheet includes a non-uniform aperture ratio for light transmission to inhibit luminance non-uniformity of light that has passed through the resin layer.

### CROSS REFERENCE TO RELATED APPLICATION

The present application is based on and claims priority of Japanese Patent Application No. 2024-195131 filed on Nov. 7, 2024.

### FIELD

The present disclosure relates to a capacitive sensing input device.

### BACKGROUND

As related art, an electrode sheet for a capacitive touch panel has been known.

For example, Patent Literature (PTL) 1 discloses an electrode sheet for a capacitive touch panel that includes: a transparent substrate; a first conductive portion formed on one principal surface of the substrate; and a second conductive portion formed on an other principal surface of the substrate.

### CITATION LIST

### Patent Literature

PTL 1: Japanese U.S. Pat. No. 5,795,038

### SUMMARY

However, the electrode sheet for the capacitive touch panel according to PTL 1 can be improved upon.

In view of this, the present disclosure provides a capacitive sensing input device capable of improving upon the above related art.

A capacitive sensing input device according to one aspect of the present disclosure includes: a resin layer that is light transmissive and includes a front surface that is a design surface; a capacitive sensor sheet that overlaps a back surface of the resin layer; and a light source that emits light to the resin layer and the capacitive sensor sheet. The resin layer includes non-uniform light transmittance, and the capacitive sensor sheet includes a non-uniform aperture ratio for light transmission to inhibit luminance non-uniformity of light that has passed through the resin layer.

The capacitive sensing input device according to the present disclosure is capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a schematic diagram illustrating a capacitive sensing input device provided in a vehicle.

FIG. 2 is a block diagram illustrating the capacitive sensing input device.

FIG. 3 is a cross-sectional view illustrating the capacitive sensing input device.

FIG. 4 is a diagram illustrating luminance non-uniformity of light that has passed through a resin layer and exited a design surface.

FIG. 5 is a diagram illustrating a dot pattern of a light-blocking portion of a capacitive sensor sheet.

FIG. 6 is a diagram illustrating a mesh pattern of the light-blocking portion of the capacitive sensor sheet.

### DESCRIPTION OF EMBODIMENT

The following specifically describes one or more embodiments with reference to the drawings.

Note that each of the one or more embodiments described below shows a general or specific example. The numerical values, shapes, materials, structural elements, the arrangement and connection of the structural elements, etc. shown in the following one or more embodiments are mere examples, and are not intended to limit the scope of the present disclosure. In addition, among the structural elements in the following one or more embodiments, structural elements not recited in any one of the independent claims are described as optional structural elements.

Moreover, the figures are schematic diagrams and are not necessarily precise illustrations. Moreover, configurations that are essentially the same share like reference signs in the figures.

Moreover, in the following one or more embodiments, expressions such as being substantially parallel and a rectangular shape are used. For example, being substantially parallel and the rectangular shape respectively mean not only being completely parallel and a completely rectangular shape but also mean being substantially parallel and a substantially rectangular shape, or stated differently, also mean that an error of about a few percent or several percent may be included. Moreover, being substantially parallel and a rectangular shape respectively mean being parallel and a rectangular shape in a scope in which effects yielded by the present disclosure can be achieved. The same also applies to other similar expressions that include or indicate “substantially” or “shape”.

### Embodiment

### Configuration

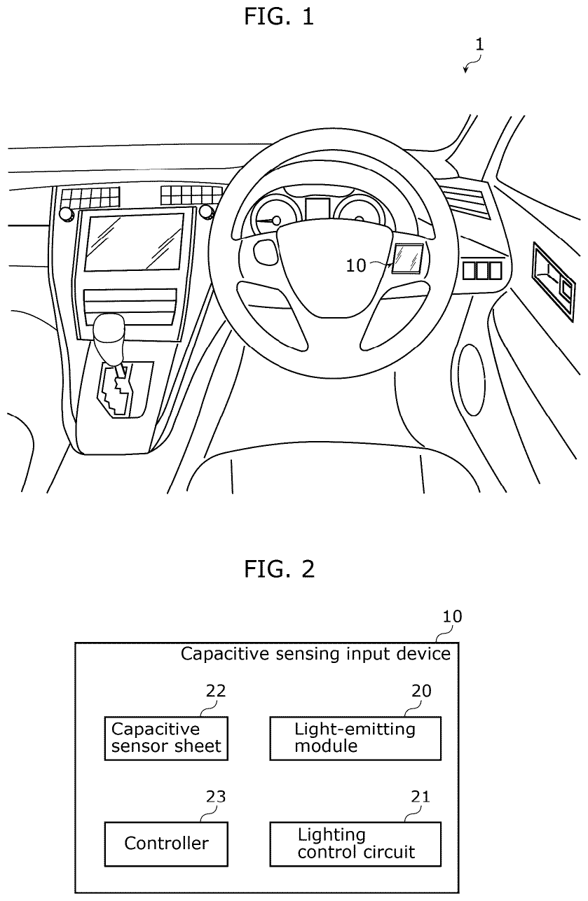

First, a configuration of capacitive sensing input device 10 will be described with reference to FIG. 1 to FIG. 6.

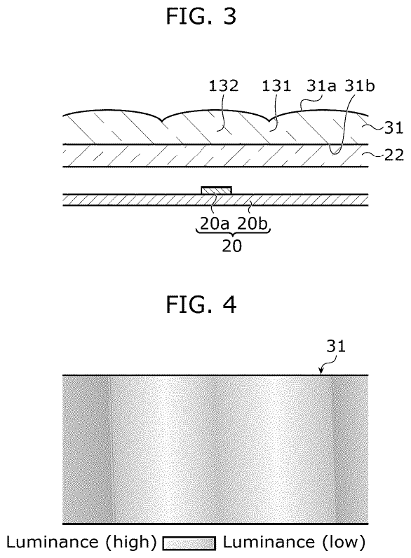

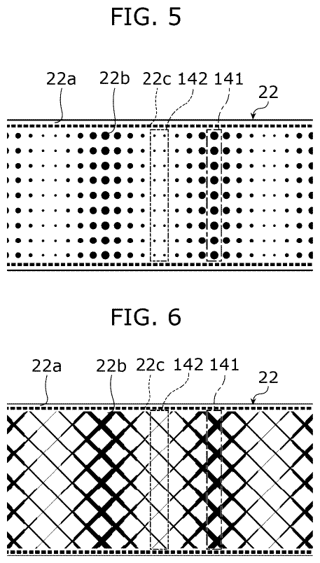

FIG. 1 is a schematic diagram illustrating capacitive sensing input device 10 provided in vehicle 1. FIG. 2 is a block diagram illustrating capacitive sensing input device 10. FIG. 3 is a cross-sectional view illustrating capacitive sensing input device 10. FIG. 4 is a diagram illustrating luminance non-uniformity of light that has passed through resin layer 31 and exited design surface 31a. FIG. 5 is a diagram illustrating a dot pattern of light-blocking portion 22b of capacitive sensor sheet 22. FIG. 6 is a diagram illustrating a mesh pattern of light-blocking portion 22b of capacitive sensor sheet 22.

As illustrated in FIG. 1, capacitive sensing input device 10 is provided to, for example, a spoke connected to a steering shaft of vehicle 1, and/or one or more of a center console, a door, an instrument panel, or a roof of vehicle 1, with its operating surface being exposed. With this, capacitive sensing input device 10 can receive operation input that has been input to the operating surface by a user. FIG. 1 illustrates an example where capacitive sensing input device 10 is provided to the spoke connected to the steering shaft of vehicle 1. Note that capacitive sensing input device 10 should not be limited to the present embodiment, and may be provided to a different portion in the cabin of vehicle 1, for example.

Upon receiving the operation input from the user, capacitive sensing input device 10 outputs a signal based on the operation input for controlling an in-vehicle device. With this, the in-vehicle device can operate according to the operation input. The in-vehicle device is, for example, a car navigation system including a display device and so on, an audio device for reproducing an optical disc, an in-vehicle air conditioning device, in-vehicle lighting, or a video reproducing device. As described above, the user can operate the in-vehicle device provided in vehicle 1 by performing operation input on capacitive sensing input device 10.

Next, a specific configuration of capacitive sensing input device 10 will be described.

As illustrated in FIG. 1 to FIG. 3, capacitive sensing input device 10 includes light-emitting module 20, lighting control circuit 21, resin layer 31, capacitive sensor sheet 22, and controller 23.

Light-emitting module 20 is disposed opposite to capacitive sensor sheet 22.

Light-emitting module 20 includes one or more light-emitting elements 20a that emit light, and substrate 20b on which the one or more light-emitting elements 20a are disposed. Light-emitting element 20a is an example of a light source. Moreover, light-emitting module 20 may be an example of a light source.

The one or more light-emitting elements 20a are disposed opposite to capacitive sensor sheet 22. The one or more light-emitting elements 20a can emit light toward resin layer 31 and capacitive sensor sheet 22.

Each of the one or more light-emitting elements 20a is, for example, a light-emitting diode (LED) that emits light (e.g., white light) using electric current supplied from lighting control circuit 21. Each of the one or more light-emitting elements 20a is, for example, a blue light-emitting element that emits blue light, a green light-emitting element that emits green light, and/or a red light-emitting element that emits red light.

The one or more light-emitting elements 20a are mounted on substrate 20b. Substrate 20b is, for example, a rigid substrate, but may be a flexible substrate. Substrate 20b includes pattern wiring for connecting each of the one or more light-emitting elements 20a and lighting control circuit 21.

Lighting control circuit 21 can individually control each of the one or more light-emitting elements 20a to turn on and off by supplying direct current power to each of the one or more light-emitting elements 20a. Moreover, lighting control circuit 21 may include a dimming function or a color-tuning function. Lighting control circuit 21 can change the light emission intensity of each of the one or more light-emitting elements 20a according to the amount of electric current supplied to each of the one or more light-emitting elements 20a. The one or more light-emitting elements 20a may include a plurality of types of light-emitting elements 20a that emit white light having different color temperatures. Lighting control circuit 21 can produce white light having a desired color temperature by adjusting the light emission intensity of each of the one or more light-emitting elements 20a. Lighting control circuit 21 may be mounted on the same substrate 20b as with the one or more light-emitting elements 20a, or may be mounted on a different substrate.

As illustrated in FIG. 3, resin layer 31 is light transmissive, and includes an acrylic sheet or glass, for example. In the present embodiment, resin layer 31 is in a rectangular shape in a plan view. Note that the shape of resin layer 31 in the plan view should not be limited to the rectangular shape, and may be a polygonal shape other than the rectangular shape, or a circular shape.

Resin layer 31 includes design surface 31a and facing surface 31b.

Design surface 31a is a front surface (operating surface) of resin layer 31 that can directly receive operation input from the user. Design surface 31a includes an uneven pattern or symbol formed thereon to indicate operation input. Facing surface 31b is a back surface of resin layer 31, which is on the opposite side from design surface 31a. Facing surface 31b is disposed to face capacitive sensor sheet 22.

As described above, since resin layer 31 includes an uneven pattern or symbol formed on design surface 31a, resin layer 31 varies in thickness. Therefore, resin layer 31 includes non-uniform light transmittance.

Specifically, resin layer 31 includes thin portion 131 having a smaller thickness and thick portion 132 having a larger thickness than thin portion 131. Resin layer 31 has a feature that thin portion 131 has a higher light transmittance, and thick portion 132 has a lower light transmittance.

In other words, the luminance of light that has passed through resin layer 31 tends to be lower as the thickness of resin layer 31 is larger. As illustrated in FIG. 3 and FIG. 4, the luminance of the light that has passed through resin layer 31 is higher in thin portion 131, and is lower in thick portion 132 than the luminance in thick portion 131.

Capacitive sensor sheet 22 is oriented substantially parallel to resin layer 31 and overlaps facing surface 31b of resin layer 31. For example, capacitive sensor sheet 22 is attached to facing surface 31b of resin layer 31 by a light-transmissive adhesive.

Capacitive sensor sheet 22 includes a non-uniform aperture ratio for light transmission to inhibit luminance non-uniformity of light that has passed through resin layer 31. Capacitive sensor sheet 22 of the present embodiment has a feature that a portion of capacitive sensor sheet 22 having a higher aperture ratio allows light to pass through at a higher luminance, i.e., the light becomes brighter.

Specifically, the aperture ratio of a portion of capacitive sensor sheet 22 is lower as the light transmittance of a portion of resin layer 31 corresponding to the portion of capacitive sensor sheet 22 is higher. In other words, the aperture ratio of a portion of capacitive sensor sheet 22 is lower as the thickness of resin layer 31 corresponding to the portion of capacitive sensor sheet 22 is smaller.

More specifically, capacitive sensor sheet 22 includes light-transmissive sheet 22a that transmits light, light-blocking portion 22b that blocks light, and one or more electrodes 22c.

Light-transmissive sheet 22a includes a light-transmissive resin material, such as polyethylene terephthalate.

For example, light-blocking portion 22b includes a metallic material, such as silver. Note that light-blocking portion 22b may include any material, as long as a material having a light absorbing function or a material having a light reflecting function is used.

Light-blocking portion 22b may include a dot pattern arranged on light-transmissive sheet 22a as illustrated in FIG. 5, or a mesh pattern as illustrated in FIG. 6. The dot pattern includes circular dots, but may be a pattern including polygonal dots. The mesh pattern is a pattern including rectangular openings, or a pattern including other polygonal openings or circular openings. Light-blocking portion 22b is formed, for example, by printing on light-transmissive sheet 22a.

Since the light transmittance of resin layer 31 is non-uniform, capacitive sensor sheet 22 is configured such that a portion of light-blocking portion 22b having a higher density per unit area corresponds to a portion of resin layer 31 having a higher light transmittance. It can be said that the aperture ratio of a portion of capacitive sensor sheet 22 is lower as the density per unit area of light-blocking portion 22b corresponding to the portion of capacitive sensor sheet 22 is higher. As described above, in capacitive sensor sheet 22, the density per unit area of light-blocking portion 22b varies to inhibit luminance non-uniformity of light that has passed through resin layer 31.

For example, capacitive sensor sheet 22 includes portion 141 indicated by a dash-dot line, which has a first aperture ratio, and portion 142 indicated by a dash-double-dot line, which has a second aperture ratio higher than the first aperture ratio. Note that portion 141 and portion 142 illustrated in FIG. 5 and FIG. 6 are mere examples, and should not be limited to the locations illustrated in FIG. 5 and FIG. 6. A portion of capacitive sensor sheet 22 that is opposite to thin portion 131 of resin layer 31 has a first aperture ratio, which is a lower aperture ratio, and a portion of capacitive sensor sheet 22 that is opposite to thick portion 132 of resin layer 31 has a second aperture ratio, which is an aperture ratio higher than the first aperture ratio.

In the present embodiment, since capacitive sensing input device 10 includes resin layer 31 and capacitive sensor sheet 22 described above, the light emitted by light-emitting element 20a exits capacitive sensing input device 10 more uniformly through resin layer 31 and capacitive sensor sheet 22.

The one or more electrodes 22c are disposed on light-transmissive sheet 22a and may be spaced apart from light-blocking portion 22b. The one or more electrodes 22c do not have to be electrically connected to light-blocking portion 22b. Note that when light-blocking portion 22b is a mesh pattern, the one or more electrodes 22c may be electrically connected to light-blocking portion 22b.

The one or more electrodes 22c can detect operation input that has been performed on design surface 31a of resin layer 31. The one or more electrodes 22c are not electrically connected to light-blocking portion 22b. Each of the one or more electrodes 22c outputs, to controller 23, a signal for detecting a position at which an operating body has touched design surface 31a.

Controller 23 can detect the position on design surface 31a at which the operation input has been performed, based on the signal detected by the one or more electrodes 22c of capacitive sensor sheet 22. Controller 23 outputs a signal that is based on the detected position to the in-vehicle device.

### Working Effects

Next, working effects of capacitive sensing input device 10 according to the present embodiment will be described.

For example, a steering switch or the like of a vehicle includes an uneven pattern formed on an operating surface for design purposes. To illuminate the operating surface, a light source may be disposed inside the steering switch. In this case, it is considered that the operating surface can be illuminated uniformly by adjusting the thickness of the resin layer included in the operating surface. However, when the electrode sheet for the capacitive touch panel according to PTL 1 is applied to a steering switch, the configuration in which this electrode sheet for the capacitive touch panel is attached to a resin layer makes it difficult to adjust the thickness of the resin layer, and difficult to inhibit luminance non-uniformity of the operating surface that emits light.

In view of this, as described above, capacitive sensing input device 10 according to Technique 1 in the present embodiment includes: resin layer 31 that is light transmissive and includes a front surface that is design surface 31a; capacitive sensor sheet 22 that overlaps a back surface of resin layer 31; and a light source (light-emitting element 20a) that emits light to resin layer 31 and capacitive sensor sheet 22, in which resin layer 31 includes non-uniform light transmittance and capacitive sensor sheet 22 includes a non-uniform aperture ratio for light transmission to inhibit luminance non-uniformity of light that has passed through resin layer 31.

With this, it can be expected to make uniform the light emitted by light-emitting element 20a and passed through capacitive sensor sheet 22 and resin layer 31.

Therefore, capacitive sensing input device 10 is capable of inhibiting luminance non-uniformity of the operating surface that emits light.

Moreover, as described above, capacitive sensing input device 10 according to Technique 2 in the present embodiment is capacitive sensing input device 10 according to Technique 1. In this case, an aperture ratio of a portion of capacitive sensor sheet 22 is lower as a light transmittance of a portion of resin layer 31 corresponding to the portion of capacitive sensor sheet 22 is higher.

With this, resin layer 31 and capacitive sensor sheet 22 can be disposed such that a portion of resin layer 31 having a lower light transmittance corresponds to a portion of capacitive sensor sheet 22 having a higher aperture ratio, and a portion of resin layer 31 having a higher light transmittance corresponds to a portion of capacitive sensor sheet 22 having a lower aperture ratio. Therefore, it is possible to inhibit luminance non-uniformity of the operating surface that emits light.

Moreover, as described above, capacitive sensing input device 10 according to Technique 3 in the present embodiment is capacitive sensing input device 10 according to Technique 1 or 2. In this case, capacitive sensor sheet 22 includes light-transmissive sheet 22a that transmits light, light-blocking portion 22b that blocks light, and one or more electrodes 22c disposed on light-transmissive sheet 22a and spaced apart from light-blocking portion 22b, light-blocking portion 22b includes a dot pattern arranged on light-transmissive sheet 22a, and light-blocking portion 22b is so disposed that an aperture ratio of a portion of capacitive sensor sheet 22 is lower as a light transmittance of a portion of resin layer 31 corresponding to the portion of capacitive sensor sheet 22 is higher.

With this, light-blocking portion 22b can be disposed such that a portion of resin layer 31 having a lower light transmittance corresponds to a portion of capacitive sensor sheet 22 having a higher aperture ratio, and a portion of resin layer 31 having a higher light transmittance corresponds to a portion of capacitive sensor sheet 22 having a lower aperture ratio. Therefore, it is possible to inhibit luminance non-uniformity of the operating surface that emits light.

Moreover, as described above, capacitive sensing input device 10 according to Technique 4 in the present embodiment is capacitive sensing input device 10 according to Technique 1 or 2. In this case, capacitive sensor sheet 22 includes light-transmissive sheet 22a that transmits light and light-blocking portion 22b that blocks light, light-blocking portion 22b includes a mesh pattern arranged on light-transmissive sheet 22a, and light-blocking portion 22b is so disposed that an aperture ratio of a portion of capacitive sensor sheet 22 is lower as a light transmittance of a portion of resin layer 31 corresponding to the portion of capacitive sensor sheet 22 is higher.

With this, light-blocking portion 22b can be disposed such that a portion of resin layer 31 having a lower light transmittance corresponds to a portion of capacitive sensor sheet 22 having a higher aperture ratio, and a portion of resin layer 31 having a higher light transmittance corresponds to a portion of capacitive sensor sheet 22 having a lower aperture ratio. Therefore, it is possible to inhibit luminance non-uniformity of the operating surface that emits light.

Moreover, as described above, capacitive sensing input device 10 according to Technique 5 in the present embodiment is capacitive sensing input device 10 according to any one of Techniques 1 to 4. In this case, resin layer 31 varies in thickness, and an aperture ratio of a portion of capacitive sensor sheet 22 is lower as a thickness of a portion of resin layer 31 corresponding to the portion of capacitive sensor sheet 22 is smaller.

With this, resin layer 31 and capacitive sensor sheet 22 can be disposed such that a portion of resin layer 31 having a higher light transmittance, which is a portion where the thickness of resin layer 31 is smaller, corresponds to a portion of capacitive sensor sheet 22 having a lower aperture ratio, and a portion of resin layer 31 having a lower light transmittance, which is a portion where the thickness of resin layer 31 is larger, corresponds to a portion of capacitive sensor sheet 22 having a higher aperture ratio. Therefore, it is possible to inhibit luminance non-uniformity of the operating surface that emits light.

### Other Variations, Etc.

Although the present disclosure has been described based on the embodiment described above, the present disclosure should not be limited to the embodiment described above.

For example, the controller and other structural elements included in the capacitive sensing input device according to the foregoing embodiment may be typically implemented as large-scale integration (LSI), which is an integrated circuit. These may be individually configured as single chips or may be configured so that part or all of them are included in a single chip.

Moreover, integration is not limited to LSI and may be implemented with a dedicated circuit or a general purpose processor. A field programmable gate array (FPGA) which is programmable after manufacture of an LSI, or a reconfigurable processor capable of reconfiguring the connections and settings of circuit cells inside an LSI may be used.

Note that in the foregoing embodiment, each structural element may include dedicated hardware, or may be implemented by executing a software program suitable for the structural element. Each structural element may be implemented by a program executor such as a CPU or processor reading and executing a software program recorded on a recording medium such as a hard disk or semiconductor memory.

Moreover, how the functional blocks are divided in the block diagram is merely exemplary. It may also be possible to implement a plurality of functional blocks as one functional block, divide one functional block into multiple functional blocks, or transfer part of the function to another functional block. Moreover, a single hardware or software unit may process the functions of a plurality of functional blocks having similar functions in parallel or by time division.

Various modifications to the exemplary embodiment described above that may be conceived by those skilled in the art and embodiments implemented by any combination of the structural elements and functions in the above embodiment without departing from the spirit of the present disclosure are also included within the present disclosure.

While an exemplary embodiment has been described herein above, it is to be appreciated that various changes in form and detail may be made without departing from the spirit and scope of the present disclosure as presently or hereafter claimed.

### Further Information About Technical Background to This Application

The disclosure of the following patent application including specification, drawings, and claims is incorporated herein by reference in their entirety: Japanese Patent Application No. 2024-195131 filed on Nov. 7, 2024.

### INDUSTRIAL APPLICABILITY

The capacitive sensing input device according to the present disclosure can be applicable to, for example, an input device provided in a vehicle.

1. A capacitive sensing input device comprising:
a resin layer that is light transmissive and includes a front surface that is a design surface;
a capacitive sensor sheet that overlaps a back surface of the resin layer; and
a light source that emits light to the resin layer and the capacitive sensor sheet, wherein
the resin layer includes non-uniform light transmittance, and
the capacitive sensor sheet includes a non-uniform aperture ratio for light transmission to inhibit luminance non-uniformity of light that has passed through the resin layer.

2. The capacitive sensing input device according to claim 1, wherein
an aperture ratio of a portion of the capacitive sensor sheet is lower as a light transmittance of a portion of the resin layer corresponding to the portion of the capacitive sensor sheet is higher.

3. The capacitive sensing input device according to claim 1, wherein
the capacitive sensor sheet includes a light-transmissive sheet that transmits light, a light-blocking portion that blocks light, and one or more electrodes disposed on the light-transmissive sheet and spaced apart from the light-blocking portion,
the light-blocking portion includes a dot pattern arranged on the light-transmissive sheet, and
the light-blocking portion is so disposed that an aperture ratio of a portion of the capacitive sensor sheet is lower as a light transmittance of a portion of the resin layer corresponding to the portion of the capacitive sensor sheet is higher.

4. The capacitive sensing input device according to claim 1, wherein
the capacitive sensor sheet includes a light-transmissive sheet that transmits light and a light-blocking portion that blocks light,
the light-blocking portion includes a mesh pattern arranged on the light-transmissive sheet, and
the light-blocking portion is so disposed that an aperture ratio of a portion of the capacitive sensor sheet is lower as a light transmittance of a portion of the resin layer corresponding to the portion of the capacitive sensor sheet is higher.

5. The capacitive sensing input device according to claim 1, wherein
the resin layer varies in thickness, and
an aperture ratio of a portion of the capacitive sensor sheet is lower as a thickness of a portion of the resin layer corresponding to the portion of the capacitive sensor sheet is smaller.
